(19) United States
(12) Patent Application Publication
(10) Pub. No.: US 2021/0252595 A1
(43) Pub. Date: Aug. 19, 2021

(54) OUTER RING FOR VARIABLE OIL PUMP AND MANUFACTURING METHOD THEREOF

(71) Applicants: Hyundai Motor Company, Seoul (KR); Kia Motors Corporation, Seoul (KR)

(72) Inventors: Hak Soo Kim, Seoul (KR); Sung Min Kim, Anyang (KR)

(21) Appl. No.: 16/883,466

(22) Filed: May 26, 2020

(30) Foreign Application Priority Data
Feb. 17, 2020 (KR) 10-2020-0019125

(51) Int. Cl. B22F 3/24; B22F 3/10; C21D 9/40; C21D 6/00; C22C 38/08; C22C 38/16; C22C 38/12

(52) U.S. Cl. CPC B22F 3/24; B22F 3/1007; C21D 9/40; C21D 6/001; B22F 2301/35; C22C 38/16; C22C 38/12; B22F 2003/247; B22F 2003/248; C22C 38/08

(57) ABSTRACT

An outer ring for a variable oil pump including 0.5 to 0.7% by weight of carbon (C), 2.9 to 3.8% by weight of nickel (Ni), 1.3 to 1.7% by weight of copper (Cu), 0.4 to 0.6% by weight molybdenum (Mo), and a remainder of iron (Fe) and unavoidable impurities, in which austenite occupies less than 15% of a total area, and a method of manufacturing the same are provided, and a method of manufacturing the same are provided.

### CROSS-REFERENCE TO RELATED APPLICATION

This application claims the benefit of priority to Korean Patent Application No. 10-2020-0019125, filed in the Korean Intellectual Property Office on Feb. 17, 2020, the entire contents of which are incorporated herein by reference.

### TECHNICAL FIELD

The present invention relates to an outer ring for variable oil pump and a method of manufacturing the same. Particularly, a content of austenite in the outer ring may be reduced and a nitride layer may be formed in the outer ring enough during an ion nitration treatment to have excellent abrasion resistance.

### BACKGROUND

In general, a vehicle engine includes a lubrication device for lubricating a working site, such as a piston or a crankshaft. The lubrication device includes an oil supplier such as an oil pump for supplying working oil such as oil to a place where lubrication is required. In a conventional gear-type oil supplier, an amount of working oil discharged in proportion to an engine RPM is adjusted. For example, the discharge amount of the working oil increases in proportion to the engine RPM. However, the gear-type oil supplier acts as a factor to lower fuel economy of an engine because the discharge amount of the working oil is adjusted in proportion to the engine RPM regardless of a lubrication state of the working oil.

To improve this problem, a variable oil pump capable of adjusting the amount of working oil flowing into the oil supplier has been proposed. The variable oil pump is a device in which a vane or pendulum is in contact with an inner diameter of an outer ring to form a pressure of the working oil. As shown in FIG. 1, a variable oil pump 100 includes a vane 10 and an outer ring 20, the vane 10 rotates through a rotating shaft, the outer ring 20 surrounds vane 10, and the working oil is introduced between the vane 10 and the outer ring 20. The outer ring in the variable oil pump has a complicated shape and requires wear resistance, and therefore usually uses a sintered material (see FIG. 2). In addition, for preventing abrasion due to friction between the vane and the outer ring, it is common to perform ion nitration treatment on the sintered material.

For example, in the related art, a method manufacturing a heat-sintered iron alloy component has been reported. The heat-sintered iron alloy component included austenitizing an iron-based sintered body having a martensite modification start point (an Ms point) of 50 to 350° C. and includes 0.2 to 1.6% by weight of carbon and a remainder of iron, so the method includes quenching the austenitized sintered body, and sizing or stamping the quenched sintered body.

In addition, the outer ring in the conventional variable oil pump is subjected to a steam treatment or an ion nitration treatment to improve the wear resistance. For example, a main material of the conventional outer ring, FD-0408 (Fe-4Ni-0.5Mo-1.5Cu-0.6C), is excellent in formability and it is possible to manufacture the outer ring with a total density of 7.0 or greater. However, in the manufactured outer ring, an austenite structure remaining by nickel (Ni) and carbon (C) inhibits a surface nitride layer formation during the ion nitration treatment. In addition, the outer ring manufactured using FD-0408 has a variety of microstructures and fractions depending on a powder production method and a sintering condition in FD-0408. When a maximum content of the austenitic outer ring manufactured is about 35%, there is a problem in that the formation of a nitride layer by the ion nitration treatment is weak and the wear resistance is insufficient.

Therefore, development of an outer ring for the variable oil pump, which has an appropriate amount of austenite to sufficiently form the nitride layer by the ion nitration treatment, and therefore is excellent in abrasion resistance and mechanical characteristics, is required.

### SUMMARY

In preferred aspect, provided are an outer ring for variable oil pump, which has an appropriate amount of austenite to sufficiently form a nitride layer by an ion nitration treatment, and therefore is excellent in abrasion resistance and mechanical characteristics, and a method of manufacturing the same.

In an aspect, provided is an outer ring for a variable oil pump including an amount of about 0.5 to 0.7% by weight of carbon (C), an amount of about 2.9 to 3.8% by weight of nickel (Ni), an amount of about 1.3 to 1.7% by weight of copper (Cu), an amount of about 0.4 to 0.6% by weight molybdenum (Mo), and a remainder of iron (Fe) and unavoidable impurities, as % by weight is based on the total weight of the outer ring. In particular, austenite occupies less than about 15% of a total area of the outer ring, or in certain aspects austenite occupies less than about 14%, 13%, 12%, 11%, 10% or 9% of a total area of the outer ring, and in certain embodiments, austenite occupies is present and occupies at least about 1%, 2%, 3%, 4%, 5%, 6% or 7% of a total area of the outer ring but less than the above noted amounts.

The outer ring may suitably have a yield strength of about 400 MPa or greater, which is measured by a method of ISO 2740. In addition, the outer ring may suitably have a tensile strength of about 670 MPa or greater, and a hardness of about 92 HRB or greater, which is measured by Rockwell B scale.

Further provided is a variable oil pump for a vehicle including the outer ring as described herein.

In an aspect, provided is a method of manufacturing an outer ring for a variable oil pump. The method may include: preparing a composition including a first diffusion bonding powder, a second diffusion bonding powder and a carbon powder; preparing a sintered body by compacting and sintering the composition; and sizing an outer ring from the sintered body by machining of inner diameter and both-sided of the sintered body.

The first diffusion bonding powder may have a greater nickel (Ni) content than the second diffusion bonding powder.

The outer ring may suitably include an amount of about 0.5 to 0.7% by weight of carbon (C), an amount of about 2.9 to 3.8% by weight of nickel (Ni), an amount of about 1.3 to 1.7% by weight of copper (Cu), an amount of about 0.4 to 0.6% by weight molybdenum (Mo), and a remainder of iron (Fe) and unavoidable impurities, as the % by weight is based on the total weight of the outer ring.

Particularly, the austenite may occupy less than about 15% of a total area of the outer ring.

The first diffusion bonding powder may suitably include an amount of about 3.5 to 4.5% by weight of nickel (Ni), an amount of about 1.3 to 1.7% by weight of copper (Cu), an amount of about 0.4 to 0.6% by weight of molybdenum (Mo), and the remainder of iron (Fe) and unavoidable impurities, % by weight based on the total weight of the first diffusion bonding powder.

The second diffusion bonding powder may suitably include an amount of about 1.5 to 2.0% by weight of nickel (Ni), an amount of about 1.3 to 1.7% by weight of copper (Cu), an amount of about 0.4 to 0.6% by weight of molybdenum (Mo), and the remainder of iron (Fe) and unavoidable impurities,% by weight based on the total weight of the second diffusion bonding powder.

The composition may suitably include an amount of about 55 to 85 parts by weight of the first diffusion bonding powder and an amount of about 15 to 45 parts by weight of the second diffusion bonding powder.

The sintering may be carried out for about 20 to 50 minutes at a temperature of about 1,100 to 1,200° C. The sintering uses a sintering gas comprising an amount of about 75 to 95 parts by weight of nitrogen and 5 to 25 parts by weight of hydrogen.

The method may further include performing an ion nitration treatment after the machining of inner diameter. The ion nitration treatment may be performed after the machining of inner diameter before the machining of both-sided. The ion nitration treatment may be performed at a temperature of about 450 to 600° C. for about 2 to 10 hours.

Other aspects of the invention are disclosed infra.

### BRIEF DESCRIPTION OF THE DRAWINGS

The above and other objects, features and advantages of the present invention will be more apparent from the following detailed description taken in conjunction with the accompanying drawings:

FIG. 1 shows a cross-sectional schematic diagram of an embodiment of a variable oil pump;

FIG. 2 shows an exemplary embodiment of an outer ring for a variable oil pump;

FIG. 3 shows a 500 times enlarged photograph of an exemplary outer ring sample surface of Example 2 according to an exemplary embodiment of the present invention; and

FIG. 4 shows a 500 times enlarged photograph of an outer ring sample surface of Comparative Example 1.

### DETAILED DESCRIPTION

As described above, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, the present invention will be described in detail.

Outer Ring for Variable Oil Pump

In an aspect, provided is an outer ring for a variable oil pump may include an amount of about 0.5 to 0.7% by weight of carbon (C), an amount of about 2.9 to 3.8% by weight of nickel (Ni), an amount of about 1.3 to 1.7% by weight of copper (Cu), an amount of about 0.4 to 0.6% by weight molybdenum (Mo), and a remainder of iron (Fe) and unavoidable impurities, % by weight is based on the total weight of the outer ring. Particularly, austenite occupies less than about 15% of a total area of the outer ring.

Preferably, the outer ring may include an amount of about 0.54 to 0.66% by weight of carbon, an amount of about 3.0 to 3.7% by weight of nickel, an amount of about 1.35 to 1.65% by weight of copper, an amount of about 0.45 to 0.55% by weight of molybdenum, and a remainder of iron (Fe) and unavoidable impurities, % by weight based on the total weight of the outer ring. In addition, the outer ring may include about 5 to 14%, or about 7 to 13% of austenite based on the total area. Further, a density of the outer ring may be of about 7.0 to 7.15 g/cm³ or of about 7.05 to 7.15 g/cm³. When a content of the austenite in the outer ring is within the above range, an elongation of the outer ring may be less than about 1% to prevent a problem of being sensitive to external impact and a problem of deterioration in wear resistance due to reduction of surface nitride layer formation during an ion nitration treatment.

In addition, the outer ring may include an amount of about 0.2% by weight or less of manganese (Mn) as impurities based on the total weight of the outer ring.

The outer ring may have a yield strength of about 400 MPa or greater, which is measured by a method of an ISO 2740, or about 410 MPa or greater, a tensile strength of about 670 MPa or greater, and a hardness of about 92 HRB or greater, which is measured by Rockwell B scale.

Furthermore, the outer ring may include a surface having nitride layer. The nitride layer may have an average thickness of about 3 to 15 μm, or about 5 to 8 μm.

As described above, the outer ring for the variable oil pump may have a sufficient content of austenite to form a nitride layer by the ion nitration treatment, and thus is excellent in wear resistance and mechanical characteristics.

Variable Oil Pump for Vehicle

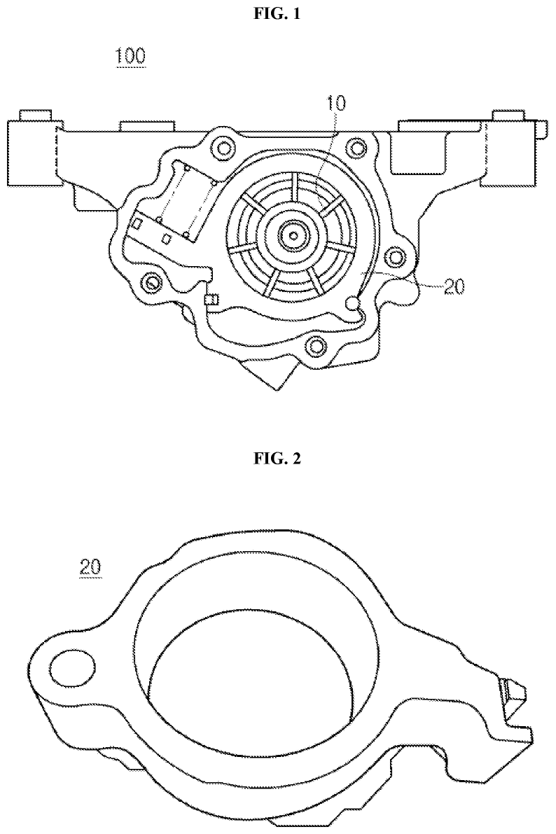

In an aspect, the variable oil pump for a vehicle may include the outer ring. As shown in FIGS. 1 and 2, the variable oil pump 100 may include the vane 10 which rotates through a rotating shaft and the outer ring 20 whose inner diameter is in contact with the vane 10.

The variable oil pump for the vehicle as described above, includes the outer ring, and thus is excellent in mechanical characteristics such as wear resistance, yield strength, tensile strength, hardness, and the like.

Method of Manufacturing Outer Ring for Variable Oil Pump

In an aspect, a method of manufacturing an outer ring for a variable oil pump includes: preparing, by mixing, a composition including a first diffusion bonding powder, a second diffusion bonding powder, and a carbon powder to prepare a composition; preparing a sintered body by compacting and sintering the composition; and sizing the outer ring from the sintered body by machining of inner diameter and both-sided of the sintered body.

Here, the “diffusion bonding powder” refers to a mixture of annealing after mixing a mother powder including iron (Fe), and nickel (Ni), molybdenum (Mo), and copper (Cu), and means that alloy components such as nickel, molybdenum, copper, and the like penetrates into a surface of the mother powder to allow the alloy powder to be bonded to the mother powder. When the diffusion bonding powders are molded and sintered, the alloy components which are attached to the surface of the mother powder are diffused into the mother powder, additionally.

Preparing Composition

The first diffusion bonding powder, the second diffusion bonding powder, and the carbon powder are mixed to prepare the composition.

The first diffusion bonding powder has a higher nickel (Ni) content than the second diffusion bonding powder.

<First Diffusion Bonding Powder>

The first diffusion bonding powder serves to supply a remainder of alloy component which is not diffused into the mother powder depending on solid solution limit of the alloy component.

The first diffusion bonding powder may suitably include an amount of about 3.5 to 4.5% by weight, or an amount of about 3.8 to 4.2% by weight of nickel (Ni), an amount of about 1.3 to 1.7% by weight, or an amount of about 1.35 to 1.65% by weight of copper (Cu), an amount of about 0.4 to 0.6% by weight, or an amount of about 0.45 to 0.55% by weight of molybdenum (Mo), and a remainder of iron (Fe) and unavoidable impurities, % by weight is based on the total weight of the first diffusion bonding powder.

In addition, the first diffusion bonding powder may include an amount of about 0.2% by weight or less of manganese (Mn) as impurities.

The first diffusion bonding powder may include an amount of about 10% by weight or less, an amount of about 5.7 to 7.5% by weight, or an amount of about 6.1 to 7.1% by weight of a total amount of nickel, copper, and molybdenum based on a total amount of the powder. When the total amount of nickel, copper and molybdenum in the first diffusion bonding powder is within the above range, influence of physical characteristics depending on the content of nickel (Ni) may be increased.

In addition, the first diffusion bonding powder may be included in the composition in an amount of about 55 to 85 parts by weight based on about 15 to 45 parts by weight of the second diffusion bonding powder. The first diffusion bonding powder may be included in the composition in an amount of about 60 to 80 parts by weight, or about 64 to 74 parts by weight based on about 15 to 45 parts by weight of the second diffusion bonding powder. When the content of the first diffusion bonding powder is in the above range, the amount of diffusion of the undissolved nickel (Ni) is increased toward the alloy having low nickel amount.

<Second Diffusion Bonding Powder>

The second diffusion bonding powder serves to solidify the remainder of the alloy component in a sintering process.

The second diffusion bonding powder may include an amount of about 1.5 to 2.0% by weight of nickel (Ni), an amount of about 1.3 to 1.7% by weight of copper (Cu), an amount of about 0.4 to 0.6% by weight of molybdenum (Mo), and a remainder of iron (Fe) and unavoidable impurities, % by weight is based on the total weight of the second diffusion bonding powder. The second diffusion bonding powder may include an amount of about 1.55 to 1.95% by weight or an amount of about 1.575 to 1.925% by weight of nickel (Ni), an amount of about 1.35 to 1.65% by weight of copper (Cu), an amount of about 0.45 to 0.55% by weight of molybdenum (Mo), and the remainder of iron (Fe) and unavoidable impurities, % by weight is based on the total weight of the second diffusion bonding powder.

In addition, the second diffusion bonding powder may include an amount of about 0.2% by weight or less of manganese (Mn) as impurities, % by weight is based on the total weight of the second diffusion bonding powder.

The second diffusion bonding powder may include about 10% by weight or less, about 3.7 to 5.0% by weight, or about 3.85 to 4.85% by weight of a total amount of nickel, copper, and molybdenum based on the total amount of the powder. When the total amount of nickel, copper and molybdenum in the second diffusion bonding powder is within the above range, the alloy component may solidify additionally.

The second diffusion bonding powder may be included in the composition in an amount of about 15 to 45 parts by weight, about 20 to 40 parts by weight, or about 26 to 36 parts by weight based on about 55 to 85 parts by weight of the first diffusion bonding powder. When the content of the second diffusion bonding powder is in the above range, the alloy component diffusion amount may be increased to the maximum when mixing with the first diffusion bonding powder.

The carbon powder may be included in an amount of about 0.5 to 0.7% by weight or about 0.54 to 0.66% by weight based on the total weight of the composition.

In the sintering process, carbon and nickel in the composition may be diffused into iron to form martensite to improve strength, and an area where carbon and nickel are diffused in high concentration may form austenite. The austenite may inhibit formation of a nitride layer on a surface of an outer ring to be manufactured during the ion nitration treatment to cause the outer ring to have low wear resistance. In addition, excessively lowering the content of nickel in the composition may reduce the content of martensite by low concentration of nickel diffusion, thereby lowering the strength of the outer ring to be manufactured. The composition may include an amount of about 0.5 to 0.7% by weight or an amount of about 0.54 to 0.66% by weight of carbon and an amount of about 2.7 to 4.0% by weight, or an amount of about 2.9 to 3.8% by weight of nickel, based on the total weight.

In addition, in the sintering process, the composition may have a diffusion rate in order of carbon, copper, molybdenum, and nickel in iron (Fe). Nickel may have the slowest diffusion rate to be additionally diffused into an area where copper, molybdenum, carbon, and the like are already diffused, or to allow copper, molybdenum, carbon, and the like of the powder adjacent to an area where nickel is diffused to be diffused additionally. The diffusion of nickel in the sintering process may be increased when the composition includes two diffusion bonding powders having different nickel contents than when composition includes two diffusion bonding powders having the same nickel content or one diffusion boding powder, and thus the content of martensite and/or pearlite in the outer ring to be manufactured may be increased and the content of austenite may be decreased. This is because diffusion of nickel in an area where copper, molybdenum, carbon, and the like are diffused occurs more actively than diffusion of copper, molybdenum, carbon, and the like in an area where the nickel is diffused.

Preparing Sintered Body

The composition is compacted and sintered to prepare the sintered body.

The compacting is not particularly limited as long as it is applicable in manufacturing an outer ring for a variable oil pump.

The sintering may be performed at a temperature of about 1,100 to 1,200° C. or about 1,110 to 1,150° C. for about 20 to 50 minutes or about 25 to 40 minutes. Here, the sintering may use a sintering gas containing about 75 to 95 parts by weight or about 80 to 90 parts by weight of nitrogen, and about 5 to 25 parts by weight or about 10 to 20 parts by weight of hydrogen.

The sintered body may be one in which nickel, copper, molybdenum, carbon, and the like may be diffused into the mother powder including iron (Fe), thereby powder compacting martensite and austenite.

Processing

The sintered body may be sized, machined of inner diameter and machined of both-sided.

The sizing, machining of inner diameter, and machining of both-sided are not particularly limited as long as it is applicable in the manufacturing method of the outer ring for the variable oil pump, generally.

The manufacturing method may further include performing an ion nitration treatment after the machining of inner diameter. For example, the manufacturing method may include the performing of the ion nitration treatment and the machining of both-sided after sizing the sintered body and the machining of inner diameter, or the performing of the ion nitration treatment after sizing the sintered body, the machining of inner diameter, and the machining of both-sided.

Particularly, in the manufacturing method, the performing of the ion nitration treatment may be performed before the machining of both-sided after the machining of inner diameter. For example, the sintered body may be shaped, machined of inner diameter, performed the ion nitration treatment, and machined of both-sided. As described above, when the ion nitration treatment is performed between the machining of inner diameter and the machining of both-sided, a parallism of the manufactured outer ring may be substantially improved.

Performing Ion Nitration Treatment

The ion nitration treatment may be performed on the sintered body which is machined of inner diameter to form a nitride layer on the surface.

The ion nitration treatment may be performed at a temperature of about 450 to 600° C. or about 550 to 590° C. for about 2 to 10 hours or about 3 to 5 hours. The ion nitration treatment may generally use a nitrogen mixed gas which is used upon a ion nitration treatment.

The nitride layer may have an average thickness of about 3 to 15 μm, or about 5 to 8 μm.

In particular, the austenite of the prepared sintered body may have a sufficient content to sufficiently form the nitride layer by the ion nitration treatment, and thus the outer ring excellent in wear resistance and mechanical characteristics may be manufactured.

### EXAMPLE

Hereinafter, the present invention will be described in more detail with reference to Examples. However, Examples are only for the understanding of the present invention, and the scope of the present invention in any sense is not limited to Examples.

### Example 1. Preparation of Composition for Outer Ring

0.6% by weight of carbon powder was mixed with a first diffusion bonding powder including 4% by weight of nickel, 1.5% by weight of copper, 0.5% by weight of molybdenum, and a remainder of iron and inevitable impurities to prepare a first mixture. In addition, 0.6% by weight of carbon powder was mixed with a second diffusion bonding powder including 1.75% by weight of nickel, 1.5% by weight of copper, 0.5% by weight of molybdenum, and a remainder of iron and unavoidable impurities to prepare a second mixture.

Then, 80 parts by weight of the first mixture and 20 parts by weight of the second mixture were mixed to prepare the composition for the outer ring.

### Comparative Examples 1 to 4

Diffusion bonding powders having components as described in Table 1 were used.

### Examples 2 and 3 and Comparative Examples 5 to 7

The first diffusion bonding powder and the second diffusion bonding powder, which had components as described in Table 1, were mixed to prepare the compositions for the outer ring.

TABLE 1

| | First Mixture | Second Mixture | |
|---|---|---|---|
| | (0.6C—4Ni—1.5Cu—0.5Mo) | (0.6C—1.75Ni—1.5Cu—0.5Mo) | Component |
| Comparative | — | — | 3.98Ni—1.52Cu—0.52Mo—0.74C |
| Example 1 | | | |
| Comparative | — | — | 3.98Ni—1.52Cu—0.52Mo—0.63C |
| Example 2 | | | |
| Comparative | — | — | 3.29Ni—1.51Cu—0.49Mo—0.61C |
| Example 3 | | | |
| Comparative | — | — | 1.77Ni—1.48Cu—0.51Mo—0.62C |
| Example 4 | | | |
| Comparative | 90 parts by weight | 10 parts by weight | 3.76Ni—1.51Cu—0.52Mo—0.63C |
| Example 5 | | | |
| Example 1 | 80 parts by weight | 20 parts by weight | 3.54Ni—1.51Cu—0.52Mo—0.63C |
| Example 2 | 69 parts by weight | 31 parts by weight | 3.29Ni—1.51Cu—0.52Mo—0.63C |
| Example 3 | 60 parts by weight | 40 parts by weight | 3.09Ni—1.50Cu—0.52Mo—0.63C |
| Comparative | 50 parts by weight | 50 parts by weight | 2.87Ni—1.50Cu—0.52Mo—0.63C |
| Example 6 | | | |
| Comparative | 30 parts by weight | 70 parts by weight | 2.43Ni—1.49Cu—0.51Mo—0.62C |
| Example 7 | | | |

### Test Example: Characteristics Evaluation of Manufactured Part

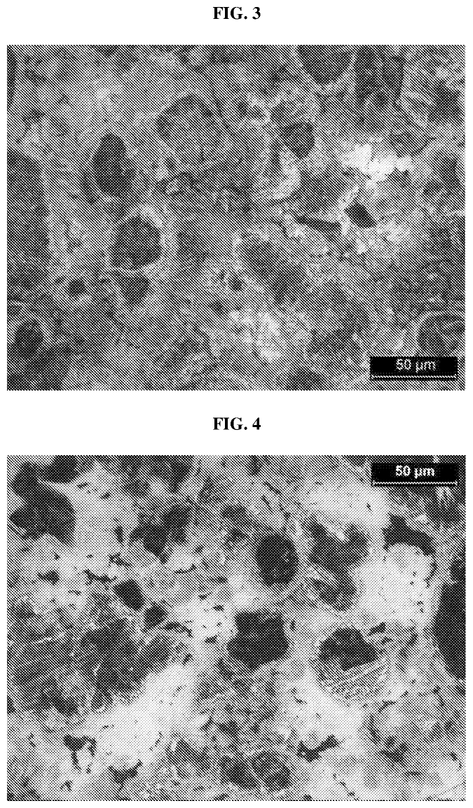

Physical characteristics of samples prepared from the compositions for the outer ring or the diffusion bonding powders of Examples and Comparative Examples were measured in the following manner, and results were shown in Table 2 and FIGS. 3 and 4.

In detail, the compositions for the outer ring of the Examples and Comparative Examples or the diffusion bonding powders were pressed under a pressure of 6 t/cm² to obtain a donut shaped molded-product having an outer diameter of 40 mm, an inner diameter of 27 mm, and a thickness of 10 mm. Thereafter, the molded product was sintered under a sintering gas atmosphere containing nitrogen and hydrogen in a volume ratio of 8:2 and at a temperature of 1,150° C. for 30 minutes to obtain a sintered body. Thereafter, the sintered body was sized, machined of inner diameter, and performed the ion nitration treatment at a temperature of 570° C. for 4 hours while injecting a nitrogen gas mixture. After machining of both-sided were performed to prepare the outer ring samples.

(1) Austenite Content

The surface of each outer ring sample was immersed in 5% nitric acid-containing alcohol solution for 5 seconds, washed with water and alcohol and dried. Then, the austenite content was measured on the surface of each outer ring sample using an image analysis program (Manufacturer: iMTechnology, Model name: i-SOLUTION). After observations 10 times, an average was calculated and used as the austenite content.

In addition, the surface of each outer ring sample was taken at 500 times enlarged ratio shown in FIGS. 3 and 4, FIG. 3 shows the result of an outer ring sample prepared from the composition of Example 2, and FIG. 4 shows the result of an outer ring sample prepared from a diffusion bonding power of Comparative Example 1. In this case, black or dark grey is referred to as pearlite or bainite, light grey is referred to as martensite, and white is referred to as austenite.

(2) Tensile Strength, Yield Strength, and Elongation

When a flat section was secured in each outer ring sample, a specimen as long as possible was taken to measure the tensile strength, yield strength and elongation by a method of ISO 2740.

(3) Core Hardness

Hardness of the outer ring samples was measured using a Rockwell B scale to be used as the core hardness.

TABLE 2

| | | | Tensile | Core | Austenite | | |
|---|---|---|---|---|---|---|---|
| | Component of | Density | Strength | Hardness | content | Yield | Elongation |
| | Sintered Body | (g/cm³) | (MPa) | (HRB) | (%) | (MPa) | (%) |
| Comparative | 3.98Ni—1.52Cu—0.52Mo—0.74C | 7.07 | 653 | 91.3 | 22.7% | 368 | 2.64 |
| Example 1 | | | | | | | |
| Comparative | 3.98Ni—1.52Cu—0.52Mo—0.63C | 7.08 | 664 | 90.3 | 21.1% | 373 | 2.52 |
| Example 2 | | | | | | | |
| Comparative | 3.29Ni—1.51Cu—0.49Mo—0.61C | 7.08 | 648 | 88.8 | 15.8% | 366 | 2.21 |
| Example 3 | | | | | | | |
| Comparative | 1.77Ni—1.48Cu—0.51Mo—0.62C | 7.07 | 614 | 85.7 | 4.6% | 346 | 1.15 |
| Example 4 | | | | | | | |
| Comparative | 3.76Ni—1.51Cu—0.52Mo—0.63C | 7.09 | 669 | 91.4 | 15.5% | 391 | 2.18 |
| Example 5 | | | | | | | |
| Example 1 | 3.54Ni—1.51Cu—0.52Mo—0.63C | 7.09 | 676 | 92.7 | 12.2% | 416 | 1.97 |
| Example 2 | 3.29Ni—1.51Cu—0.52Mo—0.63C | 7.09 | 683 | 93.1 | 8.6% | 430 | 1.69 |
| Example 3 | 3.09Ni—1.50Cu—0.52Mo—0.63C | 7.08 | 675 | 92.3 | 7.0% | 418 | 1.44 |
| Comparative | 2.87Ni—1.50Cu—0.52Mo—0.63C | 7.10 | 663 | 91.5 | 6.0% | 390 | 1.29 |
| Example 6 | | | | | | | |
| Comparative | 2.43Ni—1.49Cu—0.51Mo—0.62C | 7.09 | 645 | 90.8 | 5.2% | 372 | 1.23 |
| Example 7 | | | | | | | |

As shown in Table 2, Examples 1 to 3 had the proper austenite content and thus showed excellent mechanical characteristics such as tensile strength, core hardness, and yield strength.

On the other hand, Comparative Examples 1 to 4 using one type of diffusion bonding powder and Comparative Examples 5 to 7 having a low nickel content of the sintered body lacked mechanical strength such as tensile strength, core hardness, yield strength, and the like.

Also, as shown in FIGS. 3 and 4, the outer ring sample prepared from the composition of Example 2 had high content of light grey martensite and low content of white austenite as compared to the outer ring sample prepared from the diffusion bonding powder of Comparative Example 1, and thus the nitride layer was sufficiently was formed by the ion nitration treatment to be excellent in wear resistance and mechanical characteristics.

The outer ring variable oil pump according to various exemplary embodiments of the present invention may have the appropriate amount of the austenite to sufficiently form the nitride layer by the ion nitration treatment, and therefore may be excellent in abrasion resistance and mechanical characteristics. Thus, the outer ring may be very suitable for application as a material for an automobile part.

Hereinabove, although the present invention has been described with reference to various exemplary embodiments and the accompanying drawings, the present invention is not limited thereto, but may be variously modified and altered by those skilled in the art to which the present invention pertains without departing from the spirit and scope of the present invention claimed in the following claims.

What is claimed is:

1. An outer ring for a variable oil pump comprising:
an amount of about 0.5 to 0.7% by weight of carbon (C);
an amount of about 2.9 to 3.8% by weight of nickel (Ni);
an amount of about 1.3 to 1.7% by weight of copper (Cu);
an amount of about 0.4 to 0.6% by weight molybdenum (Mo); and
a remainder of iron (Fe) and unavoidable impurities,
all the % by weight based on the total weight of the outer ring,
wherein austenite occupies less than 15% of a total area of the outer ring.

2. The outer ring for the variable oil pump of claim 1, wherein the outer ring has a yield strength of about 400 MPa or greater, which is measured by a method of ISO 2740, a tensile strength of about 670 MPa or greater, and a hardness of about 92 HRB or greater, which is measured by Rockwell B scale.

3. A variable oil pump for a vehicle comprising an outer ring of claim 1.

4. A method of manufacturing an outer ring for a variable oil pump, comprising:
preparing a composition comprising a first diffusion bonding powder, a second diffusion bonding powder and a carbon powder;
preparing a sintered body by compacting and sintering the composition; and
sizing an outer ring from the sintered body by machining of inner diameter and both-sided of the sintered body,
wherein the first diffusion bonding powder has a greater nickel (Ni) content than the second diffusion bonding powder, and
wherein the outer ring comprises an amount of about 0.5 to 0.7% by weight of carbon (C), an amount of about 2.9 to 3.8% by weight of nickel (Ni), an amount of about 1.3 to 1.7% by weight of copper (Cu), an amount of about 0.4 to 0.6% by weight molybdenum (Mo), and a remainder of iron (Fe) and unavoidable impurities, % by weight based on the total weight of the outer ring, and austenite occupies less than 15% of a total area of the outer ring.

5. The method of claim 4, wherein the first diffusion bonding powder comprises an amount of about 3.5 to 4.5% by weight of nickel (Ni), an amount of about 1.3 to 1.7% by weight of copper (Cu), an amount of about 0.4 to 0.6% by weight of molybdenum (Mo), and the remainder of iron (Fe) and unavoidable impurities, % by weight based on the total weight of the first diffusion bonding powder.

6. The method of claim 4, wherein the second diffusion bonding powder comprises an amount of about 1.5 to 2.0% by weight of nickel (Ni), an amount of about 1.3 to 1.7% by weight of copper (Cu), an amount of about 0.4 to 0.6% by weight of molybdenum (Mo), and the remainder of iron (Fe) and unavoidable impurities, % by weight based on the total weight of the second diffusion bonding powder.

7. The method of claim 4, wherein the composition comprises an amount of about 55 to 85 parts by weight of the first diffusion bonding powder and an amount of about 15 to 45 parts by weight of the second diffusion bonding powder.

8. The method of claim 4, wherein the sintering is carried out for about 20 to 50 minutes at a temperature of about 1,100 to 1,200° C.

9. The method of claim 4, wherein the sintering uses a sintering gas comprising an amount of about 75 to 95 parts by weight of nitrogen and 5 to 25 parts by weight of hydrogen.

10. The method of claim 4, further comprising:
performing an ion nitration treatment after the machining of inner diameter.

11. The method of claim 10, wherein the ion nitration treatment is performed after the machining of inner diameter before the machining of both-sided.

12. The method of claim 10, wherein the ion nitration treatment is performed at a temperature of about 450 to 600° C. for about 2 to 10 hours.
